(19) United States
(12) Patent Application Publication
(10) Pub. No.: US 2017/0374333 A1
(43) Pub. Date: Dec. 28, 2017

(54) REAL-TIME MOTION CAPTURE AND PROJECTION SYSTEM

(71) Applicant: Wieden + Kennedy, Inc., Portland, OR (US)

(72) Inventors: Nilesh Ashra, Portland, OR (US); Rafael Kfouri de Vilhena Nunes, Portland, OR (US); David Glivar, Portland, OR (US); Keith Eric Hamilton, West Linn, OR (US); Zhao He, Portland, OR (US); Michael Alexander Latzoni, Beaverton, OR (US); Paulo Joao Ribeiro, Portland, OR (US); Tera Hatfield, Portland, OR (US); Ryan Kee, Portland, OR (US)

(21) Appl. No.: 15/634,753

(22) Filed: Jun. 27, 2017

Related U.S. Application Data
(60) Provisional application No. 62/355,179, filed on Jun. 27, 2016.

(51) Int. Cl. H04N 9/31; G06T 7/292; G06T 7/70

(52) U.S. Cl. CPC H04N 9/3194; G06T 7/70; H04N 9/3182; H04N 9/3147; G06T 7/292; H04N 9/3185; G06T 2207/10048; G06T 2207/30196; G06T 2207/30204

(57) ABSTRACT

Systems and techniques are provided for a real-time motion capture and projection system. Infrared cameras may be positioned in an area. The infrared cameras may generate infrared images of portions of the area and transmit the infrared images as motion capture data. An image processing system may receive the motion capture data from the infrared cameras and generate projector instructions. Projectors may be positioned in the area. The projectors may receive the projector instructions from the image processing system and project visible light according to the projector instructions.

### BACKGROUND

Motion capture systems may include infrared cameras in an enclosed space and image processing equipment associated with the infrared cameras. To track the movement of a target, such as a human being, a large number of visible infrared markers may be provided at various points on the body of the target or on the clothing, shoes or headwear worn by the target.

The infrared markers may be positioned to mark key areas of the target to allow the infrared cameras and image processing equipment to identify and track each of the infrared markers. For example, to track the movement of shoes worn by the target, infrared markers may be provided at various points on surfaces of the shoes.

### BRIEF SUMMARY

In an implementation, infrared cameras may be positioned in an area. The infrared cameras may generate infrared images of portions of the area and transmit the infrared images as motion capture data. An image processing system may receive the motion capture data from the infrared cameras and generate projector instructions. Projectors may be positioned in the area. The projectors may receive the projector instructions from the image processing system and project visible light according to the projector instructions.

Systems and techniques disclosed herein may allow for a real-time motion capture and projection system. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for a real-time motion capture and projection system according to an implementation of the disclosed subject matter.

FIG. 2A shows an example system suitable for a real-time motion capture and projection system according to an implementation of the disclosed subject matter.

FIG. 2B shows an example system suitable for a real-time motion capture and projection system according to an implementation of the disclosed subject matter.

FIG. 3 shows an example system suitable for a real-time motion capture and projection system according to an implementation of the disclosed subject matter.

FIG. 4 shows an example procedure suitable for a real-time motion capture and projection system according to an implementation of the disclosed subject matter.

FIG. 5 shows a computer according to an embodiment of the disclosed subject matter.

FIG. 6 shows a network configuration according to an embodiment of the disclosed subject matter.

### DETAILED DESCRIPTION

According to embodiments disclosed herein, a real-time motion capture and projection system may allow for the projection of images on to moving objects. Sensors that can detect electromagnetic radiation in some part of the electromagnetic spectrum, acoustic waves, or signals used for wireless communication may be positioned around an area. An object, such as a shoe worn by a person, may be marked with small markers, which may be fixed to various positions on the object. For example, markers may be fixed to the upper, sides and sole of a shoe. Objects marked with markers may be target objects. Markers may be fixed to any object, and may be fixed to multiple objects, resulting in multiple target objects. For example, markers may be fixed to both shoes worn by a person, as well on the person themselves and/or the person's clothing. The markers may be reflectors or emitters for the electromagnetic radiation, acoustic waves, or wireless communication signals that are detectable by the sensors. The location and movements of target objects that have affixed markers may be captured by detecting emissions or reflections from the markers with the sensors. This motion capture data may be used to construct a virtual three-dimensional model of all or part of target objects as they are moving. Design data relevant to modifying the appearance of all or part of a target object may include data regarding an objects appearance, such as colors, textures, and patterns intended to be displayed on various areas of the target object. The motion capture data and design data may be used to generate instructions to send to one or more projectors to use visible light to apply the design specified by the design data to the target object in real-time as the target object is moving. For example, designs may be projected on to a pair of shoes, and may stay projected onto the shoes as a person wearing the shoes moves around the area. The projected designs may appear to observers to be part of the shoes themselves.

The area used for a real-time motion capture and projection system may be of any suitable type, and of any suitable size. For example, the area may be an enclosed space, such as a room, a semi-enclosed space, for example, an outdoor arena or stadium, or an unenclosed space, such as an outdoor area. The size of the area may be based on, for example, the number of sensors used and their sensitivity, and the number of projectors used and their power. For example, more powerful projectors may allow for a larger area relative to less powerful projectors due to their ability to maintain a projection that is visible over ambient light over longer distances.

Sensors may be positioned in an area in any suitable manner. The sensors may be, for example, infrared cameras. Any number of infrared cameras may be positioned on the surface of an area or elevated off the surface of an area. For example, infrared cameras may be positioned on the floor of a room, elevated off the floor with a suitable elevation device, such as a rod, tripod, or other floor-mount, or elevated off the floor through attachment to a wall, ceiling, or other elevated part of a room. The number and positons of infrared cameras used in an area may be selected to provide maximum visibility of any target objects in the area with as few infrared cameras as possible.

Infrared cameras may also be positioned beneath the surface of an area. For example, infrared cameras may be positioned beneath the floor of a room. All or part of the surface may include material that is transmissive to radiation that is outside the range of the visible parts of the spectrum, such as wavelengths from 390 to 700 nm, which may allow infrared cameras to detect infrared markers on a target object through the surface. The material may also be selectively transmissive to radiation in the visible parts of the spectrum in the range from translucent to opaque. A translucent surface may allow light, but not detailed images, to pass through. For example, a translucent surface may include a one-way transmissive film or coating. A one-way film may be a thin, perforated material that may be more reflective on the side facing up, which may be chromed or otherwise mirrored, and less reflective on the side facing down, which may not be chromed or mirrored but may be matte black. An opaque surface may block all visible light. A selectively transmissive surface in the visible parts of the spectrum may be transmissive of all or parts of the spectrum of wavelengths from about 390 to 700 nm over a range of intensities, but not allow the transmission of visible light in a way that permits a person to form detailed images of what lies on the other side of the surface based on the visible light transmitted through it. For example, the surface may be made of a one-way material that transmits some light, but prevents a person from seeing details of what is beneath the surface. The one-way material may be sufficiently transmissive, for example, to infrared radiation to a degree sufficient to permit infrared cameras positioned below the surface to detect infrared radiation from infrared markers fixed to target objects that are above the surface. The surface made be made of a material that is transmissive to infrared but opaque to visible light, such as, for example, a Plexiglas or acrylic material. Translucent Plexiglas or acrylic materials may also be used.

Infrared cameras located below the surface of an area may have fewer obstructions in their lines of sight to infrared markers on the bottom of a target object, such as on the sole of a shoes, and, in some cases, to infrared markers on other parts of the target object. Infrared cameras below the surface of an area may have a view of infrared markers not available to infrared cameras on or above the surface. Infrared cameras below the surface of an area may not be visible, or may only be partially visible, to a person above the surface.

In some implementations, acoustic sensors may be positioned below the surface of an area. The surface may be made of an acoustic transmissive material for acoustic waves outside of the range of human hearing, such as ultrasonic and/or infrasonic acoustic waves. The surface may be from translucent to opaque to visible light. The acoustic sensors may be used in conjunction with, for example, ultrasonic markers, which may be reflectors or emitters of ultrasonic acoustic waves, that may be fixed to various parts of a target object above the surface.

Motion capture data for target objects may be obtained via infrared cameras, or other sensors, positioned in an area below, on, or above the surface of the area. The motion capture data may be based, for example, on the detection of infrared markers on a target object by any infrared cameras in the area with a line of sight to the target object. The motion capture data may be processed by any suitable computing device. The computing device may be located in or near the area, or may be located remotely, and may receive the motion capture data from the infrared cameras or other sensors over any suitable wired or wireless connection, using any suitable connection or network type.

The motion capture data may be used to construct a virtual three-dimensional model of all or part of any target objects in the area while the target objects are stationary or moving. For example, a dynamic motion capture model of shoes worn by a person walking on the surface of the area may be generated by the processor when the shoes have been tagged with infrared markers. The dynamic motion capture model may be based on the motion capture data generated by infrared cameras in the area, which may capture infrared images of the area which show the location of the infrared markers on the shoes as they move through the area. The motion capture data from an infrared camera may also include timestamps for infrared images and data indicating the orientation of the infrared camera, such as azimuth and elevation angles, location of the infrared camera, for example, relative to a known location in the area, as well as optical parameters such as the focal length of the infrared camera. The locations of the infrared markers in the infrared images and data on the location and orientation of the infrared cameras may allow the location and orientation of the shoes to be determined at a given moment in time, and for the motion of the shoes to be determined across time.

Design data relevant to modifying the appearance of all or parts of target objects may be used in conjunction with the motion capture data for the target objects to generate instructions for a projector. The design data may specify a design for a target object, and may include, for example, appearance data for a target object, such as colors, shapes, textures, and patterns for various areas of the target object. For example, the design data for a shoe may include colors, shapes, textures, and patterns for different areas on the shoe. Each area on a target object may have a given shape defined by a shape boundary, which may be a regular or irregular polygon or polyhedron. The motion capture data and design data for a target object may be used to generate instructions to send to projectors, which may project an image using visible light to apply the design specified in the design data to the target object in real-time, whether the target object is moving or stationary. The instructions may specify an image, and may cause the projector to project the image, including colors, textures, shapes, and patterns onto the appropriate areas of the target object, so that the target object appears with the design specified in the design data. The image for a projector may be generated based on the location of the projector in the area.

For example, a pair of shoes marked with infrared markers and worn by a person in an area with infrared cameras may be tracked by the infrared cameras to generate motion capture data for the shoes. Design data for the shoes may be used with the motion capture data, and three-dimensional models of the shoes generated using the motion capture data, to generate instructions to cause projectors to project images which apply the design specified in the design data onto the shoes as they move around the area. The shoes may be, for example, white or a neutral color calibrated to receive the projected design so as to faithfully produce the colors as they would appear on an actual shoe that was textured and colored in accordance with the design specified design data. This may allow observers to see a realistic depiction of the design specified in the design data on shoes which are otherwise white or a neutral color while the shoes are worn by a person who is moving.

An area may have any number of projectors, positioned in any suitable manner. For example, projectors may be positioned on the surface of an area, elevated off the surface of an area with a suitable elevation device, such as a rod, tripod, or other floor-mount, or elevated off the surface of an area through attachment to a wall, ceiling, or other elevated part of the area. The number and positons of projectors used in an area may be selected to provide maximum coverage of the area with as few projectors as possible, allowing for projected images to apply designs to as much as possible of the surface of target objects within the area regardless of the position or orientation of the target objects. The projectors may be of any suitable type and any suitable power level, and may project visible light in any suitable manner. The projectors may be used in conjunction with mirrors, for example, to allow a projector to be vertically oriented and still project visible light over an area from the surface of the area upwards.

A user interface may allow design data for a target object to be created or changed. Any party, such as a wearer of the target object, which may be a shoe, or a designer, may change design data while the design specified by the design data is being projected onto the target object. This may allow the design to be adjusted iteratively, as changes in the design data may result in changes to the design being projected onto the target object, in situ. For example, a person may wear shoes with affixed infrared markers in an area with infrared cameras. The motion capture data from infrared cameras may be used with design data for the shoes to generate instructions that cause projectors in the area to project images that apply the design specified in the design data onto the shoes. The design data for one or both shoes may be changed, for example, at the user interface of a computing device, such as a laptop, tablet, or smartphone. The changes to the design data may alter the design, for example, changing colors, textures, shapes, patterns, and the sizes and shapes of areas on the shoes. The changes in the design data may result in changes to the image projected using visible light, which may appear on the shoes showing the changes to the design, as specified by the changed design data, in real time.

In some implementations, a three-dimensional model of a target object may be generated based on infrared emissions from the target object itself, without using infrared markers. For example, a foot within a shoe emits infrared radiation that passes through the shoe and may be detected by infrared cameras. The shoe may be made with a variety of materials having different infrared transmissivity. A pattern of such materials may be disposed in the shoe to produce a certain pattern, such as a grid or a geodesic pattern, where the vertices of the pattern emit infrared light in a different way than the material between the vertices. Infrared radiation from the shoe modulated by such a pattern may be used to generate three-dimensional models of the shoes.

Infrared cameras may be able to capture infrared markers marking other areas of interest on a target object, for example, on the pants, skirt, shirt, jacket, or headwear of a person, especially if there is no obstruction to the lines of sight. Moreover, the infrared markers may be visible infrared markers in the form of dots or small circles, or infrared-reflective stickers or material. For example, infrared-reflective stickers may be applied to various parts of a target object. In some implementations, the infrared markers may be active devices such as infrared emitters or infrared reflectors, which may reflect ambient infrared radiation or infrared radiation from other sources to allow the infrared cameras to track the reflectors. In some implementations, infrared radiation may be projected statically or dynamically onto the subject from sources below and/or above the surface of an area, and an implementation may capture infrared light reflected from the subject.

In some implementations, sensors other than infrared cameras may be used, in place or in addition to infrared cameras. For example, sensors may be used which detect any suitable portion of the electromagnetic spectrum or the acoustic spectrum, and may detect any suitable wireless communication signals. Markers affixed to objects, including target objects, may be based on the type of sensors in the area. For example, the markers may be light or acoustic reflectors or emitters, or RFID, Bluetooth or Wi-Fi tags. The appropriate electromagnetic radiation or acoustic frequencies may be projected into an area in order to reflect off of the markers to allow the sensors to detect the reflections. Motion capture data from a sensor may include any data suitable for representing the location of markers detected in the area by the sensor.

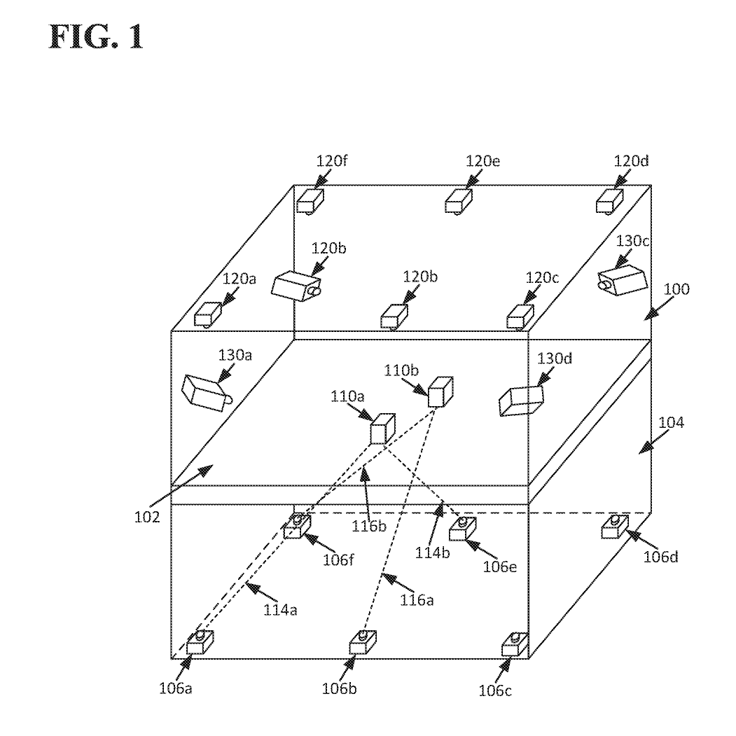

FIG. 1 shows an example system suitable for a real-time motion capture and projection system according to an implementation of the disclosed subject matter. A surface 102 of an area 100 may be transmissive to radiation in a first range of frequencies in a range of wavelengths other than from 390 to 700 nm and may be in a range from translucent to opaque to radiation with wavelengths from about 390-700 nm. The area 100 may be for example, an enclosed or semi-enclosed space, such as a room, or may be an open, unenclosed, or outdoors space. Infrared cameras 106a, 106b, 106c, 106d, 106, and 106f may be positioned in space 104 beneath the surface 102. Target objects 110a and 110b may be above the surface 102. The target objects 110a and 110b may be any suitable object, for example, shoes, clothes, or items worn by a person, or equipment, such as athletic equipment, held by a person. Infrared markers, which may be reflectors or emitters of infrared radiation, such as infrared spot markers, infrared stickers, infrared paint, or active infrared transmitters, may be placed on various surfaces of the target objects 110a and 110b, for example, depending on the shape of the target objects 110a and 110b. For example, infrared markers may be placed on the bottom surfaces of shoe soles, on the sides of the soles, and on the uppers. If a person is to be tracked, for example, a person wearing, holding, or otherwise interacting with the target objects 110a and 110b, infrared markers may be placed on the person, for example, on the legs, arms and torso. Depending on the location of the target objects 110a and 110b in the area 100, different ones of the infrared cameras 106a, 106b, 106c, 106d, 106e, and 106f may have a line of sight through the surface 102 to some of the infrared markers on the target objects 110a and 110b.

The target objects 110a and 110b may be moving within the area. For example, shoes worn by a person may move as the person stands, walks, runs, jumps or dances on the surface 102. At a given instant of time, one or both of the target objects 110a and 110b may be off the surface 102, for example, when a person wearing shoes is walking, running, jumping or dancing. The infrared markers on the target objects 110a and 110b may still be visible to some of the infrared cameras 106a, 106b, 106c, 106d, 106e, and 106f, even when the target objects 110a and 110b are not in contact with the surface 102. As long as there is no obstruction to the line of sight, one or more of the infrared cameras 106a, 106b, 106c, 106d, 106e, and 106f mounted beneath the surface 102 may track any infrared markers in the area 100, including infrared markers on a person who is wearing, holding, or otherwise interacting with the target objects 110a and 110b. The infrared cameras 106a, 106b, 106c, 106d, 106e, and 106f may also capture infrared markers that have been affixed to any moving or stationary non-human subject, such as an animal, a robot, a toy, a machine, or the like.

Implementations may track the motion of a target emitting or reflecting infrared radiation without markers. This may be done by registering the infrared signatures of all or part of the target, capturing the target's emitted or reflected infrared radiation using the infrared cameras and analyzing the captured radiation in view of the signatures. In this way, for example, the motion of a shoe covering a foot may be tracked.

The infrared cameras 106a, 106b, 106c, 106d, 106e, and 106f may be mounted at fixed positions, for example, on a floor of the space 104, on sidewalls of the space 104, or at edges or corners between the floor and the sidewalls of the space 104 for stability and ease of calibration. The infrared cameras 106a, 106b, 106c, 106d, 106e, and 106f may be movable in order to track infrared markers within the area 100 more closely. The precise location of each of the movable infrared cameras at a given instant of time may be predetermined or dynamically tracked to allow for the capture of the movements of the infrared markers.

The infrared cameras 106a, 106b, 106c, 106d, 106e, and 106f may be mounted on a horizontal surface such as a subfloor beneath surface 102 to maintain their calibration with respect to the surface 102 and target objects above the surface 102. Mounting infrared cameras 106a, 106b, 106c, 106d, 106e, and 106f on the wall may be problematic if the infrared cameras 106a, 106b, 106c, 106d, 106e, and 106f move in relation to the surface 102, which may happen if, for example, the building in which the room is situated is settling. The surface 102 may be constructed so as to depend for support upon the subfloor. For example, the surface 102 may be supported by pillars running from the subfloor to the underside of the surface 102. The surface 102 and the subfloor may then settle with the building at more of the same rate, better preserving the calibrations of the infrared cameras 106a, 106b, 106c, 106d, 106e, and 106f.

The infrared cameras 106a, 106b, 106c, 106d, 106e, and 106f may be positioned at fixed or variable locations with various geometric arrangements. For example, the bottom of the target object 110a may be, for example, the sole of a shoe, and may be in the lines of sight 114a and 114b of two of the infrared cameras 106a and 106e, respectively, to allow the infrared cameras 106a and 106e to track the bottom of the target object 110a. Likewise, the bottom of the target object 110b may be, for example, the sole of a shoes, and may be in the lines of sight 116a and 116b of two of the infrared cameras 106b and 106f, respectively, to allow the infrared cameras 106b and 106f to track the bottom of the target object 110b.

The infrared cameras 106a, 106b, 106c, 106d, 106e, and 106f may be placed at varying distances from the infrared markers being tracked to ensure reliable detection of infrared radiation and to maintain sufficiently high angular resolutions. For example, the infrared cameras 106a, 106b, 106c, 106d, 106e, and 106f may be placed at predetermined locations beneath the surface 102 such that target objects, such as the target objects 110a and 110b, being tracked are not more than 3-7 feet from the nearest infrared camera With more sensitive infrared cameras, the infrared cameras 106a, 106b, 106c, 106d, 106e, and 106f may be placed at locations such that target objects being tracked are not more than 7-12 feet from the nearest infrared camera.

The infrared cameras 106a, 106b, 106c, 106d, 106e, and 106f may be calibrated in various manners. For example, a particular marker at a known location above the surface 102 may be selected as the reference marker for calibration. For simplicity of calibration, the infrared cameras 106a, 106b, 106c, 106d, 106e, and 106f may be mounted at fixed locations in a geometric arrangement beneath the surface 102. For example, the infrared cameras 106a, 106b, 106c, 106d, 106e, and 106f may be positioned at corners and along edges in the space 104 below the surface 102. The infrared cameras 106a, 106b, 106c, 106d, 106e, and 106f may be directed at the reference marker such that the reference marker appears at the center of field of view of the infrared cameras 106a, 106b, 106c, 106d, 106e, and 106f. Parameters indicating the orientation of an infrared camera, such as azimuth and elevation angles, as well as optical parameters such as the focal length, may be used for calibration. Each of the infrared cameras 106a, 106b, 106c, 106d, 106e, and 106f may be a conventional infrared camera with a sufficiently wide field of view to cover a given area of responsibility on the surface 102. To cover the entire area of the surface 102, relatively few infrared cameras may be needed if each of the infrared cameras has a relatively wide field of view and a sufficiently high resolution. The infrared cameras 106a, 106b, 106c, 106d, 106e, and 106f may be, for example, High-Definition (HD) infrared cameras with features such as auto-zoom or auto-focus.

Any suitable number of infrared cameras may be used to track the target objects 110a and 110b in the area 100. The infrared cameras may be positioned around the area 100 in any suitable manner. For example, infrared cameras 120a, 120b, 120c, 120d, 120e, and 120f may be mounted above the surface 102, and may be in addition to, or in place of, the infrared cameras 106a, 106b, 106c, 106d, 106e, and 106f. The infrared cameras 120a, 120b, 120c, 120d, 120e, and 120f may be mounted at any suitable elevation above the surface 102. For example, the infrared cameras 120a, 120b, 120c, 120d, 120e, and 120f may be positioned to be higher than the height of a person wearing, holding, or otherwise interacting with a target object, such as the target objects 110a and 110b. The infrared cameras 120a, 120b, 120c, 120d, 120e, and 120f may be mounted at fixed locations on the ceiling, on the sidewalls, along the edges or at the corners of the area 100 for stability, or on fixed frames, columns, poles, tripods, or other structural members or floor-mounts, for example.

The infrared cameras 120a, 120b, 120c, 120d, 120e, and 120f above the surface 102 may be movable in order to track infrared markers within the area 100 more closely. The precise location of each of the infrared cameras 120a, 120b, 120c, 120d, 120e, and 120f at a given instant of time may be predetermined or dynamically tracked to capture movements of infrared markers within the area 100, including infrared red markers in locations on a target object, such as the target objects 110a and 110b, or other object or person, that may be invisible to other infrared cameras. For example, the line of sight to from the infrared cameras 106a, 106b 106c, 106d, 106e, and 106f beneath the surface 102 to certain infrared markers may be obstructed.

All of the infrared cameras positioned in the area 100, for example, the infrared cameras 106a, 106b, 106c, 106d, 106e, 106f, 120a, 120b, 120c, 120d, 120e, and 120f may capture infrared images of portions of the area 100 within their fields of vision. The infrared images may be used as motion capture data for target objects, such as the target objects 110a and 110b, and any other objects affixed with infrared markers, based on the positions of infrared markers within the infrared images. The motion capture data may also include, for example, timestamps for the various infrared image, positioning data for infrared cameras that generated the various infrared images, and other suitable data, such as the orientation of the infrared cameras, such as azimuth and elevation angles and optical parameters such as the focal length of the infrared cameras.

Projectors 130a, 130b, 130c, and 130d may be positioned in the area 100. For example, the projectors 130a, 130b, 130c, and 130d, may be positioned above the surface 102. The projectors 130a, 130b, 130c, and 130d may be any suitable visual light projectors of any suitable power level. Different projectors, for example, having different sizes and power levels, may be used in the same area 100. The projectors 130a, 130b, 130c, and 130d in the area 100 may be in communication with a computing device, including a processor, that may receive data, such as motion capture data, from the infrared cameras 106a, 106b, 106c, 106d, 106e, 106f, 120a, 120b, 120c, 120d, 120e, and 120f.

The computing device may, for example, be built-in to any of the projectors 130a, 130b, 130c, and 130d, may be a separate computing device in or near the area 100, or may be a remote computing device, such as, for example, a server system remote from the area 100. The computing device may generate a three-dimensional model of all or parts of any target objects, such as the target objects 110a and 110b, or other objects or persons affixed with infrared markers, for which there is relevant data in the motion capture data. The three-dimensional model for an object may be based on, for example, both the locations of the infrared markers affixed to the objects in the motion capture data and known properties of the size and shape of the object. For example, if the target object 110a is a shoe, the motion capture data may include the location of the sole, upper, and sides of the shoe based on the detection of infrared markers on the shoe. The computing device may include a memory that may store a pre-generated three-dimensional model of the shoe, and may use the motion capture data to determine the proper orientation and location for the three-dimensional model of the shoe within the area 100.

The memory of the computing device may store design data, which may include colors, textures, shapes, and patterns for various parts of target objects, such as the target objects 110a and 110b, specifying a design for the target objects. The memory may store design data for each target object being tracked in the area 100, including a separate design for each target object. For example, the target objects 110a and 110b may be shoes. The memory of the computing device may store separate design data for both shoes. The design specified by the design data for each shoe may be the same, adjusted for whether the design data is for the left or right shoe, or may be different, and may be changed separately or in unison. This may allow for the left and right shoe to start with the same design, and for that design to then be adjusted separately for each shoe or adjusted for both shoes at the same time to ensure the designs on each shoe match, or for the left and right shoe to start with different designs.

The computing device may generate instructions for the projectors 130a, 130b, 130c, and 130d based on the motion capture data, the three-dimensional models of any target objects, such as the target objects 110a and 110b, and the design data stored in memory. The instructions sent to a projector may include, for example, images that may be projected by the projector using visible light. Based on the projector instructions the projectors 130a, 130b, 130c, and 130d may project visible light onto one or more parts of target objects, such as the target objects 110a and 110b, causing a design specified by the design data to appear on the target objects 110a and 110b and to follow the target objects 110a and 110b as they move through the area 100. The projector instructions may include any number of color designations relating to particular colors in the design to project onto all or parts of any target objects, such as the target objects 110a and 110b. The projector instructions may also include any number of texture designations relating to textures to apply to a projection onto all or parts of any target objects. The projector instructions may also include any number of area designations relating to bounded areas on any target objects on which to project images containing a color and possibly a texture. There may be many such bounded areas on the same target object, allowing the target object to appear to be colored and textured differently in various bounded areas. This may allow for an observer to see what a target object looks like with a complex design while the target object is moving.

The computing device may use the motion capture data to track the position of target objects, such as the target objects 110a and 110b, over time. The projector instructions generated by the computing device may include directional designations to send to the projectors 130a, 130b, 130c, and 130d that may cause the projectors 130a, 130b, 130c, and 130d to correctly project the various patterns of visible light on some or all of the target objects as the positions of the target objects change over time. Any number of target objects may be tracked within the area 100, including, for example, a single target object or multiple target objects of the same or different type.

Motion capture data for objects with affixed infrared markers that are not target objects, such as, for example, a person who is wearing, holding, or interacting with a target object, may be used in any suitable manner. For example, the computing device may use motion capture data for a person to assist in determining the location and orientation of a target object in the area 100. For example, infrared markers on person may provide additional points of reference in the motion capture data for determining the position of a shoe worn by the person.

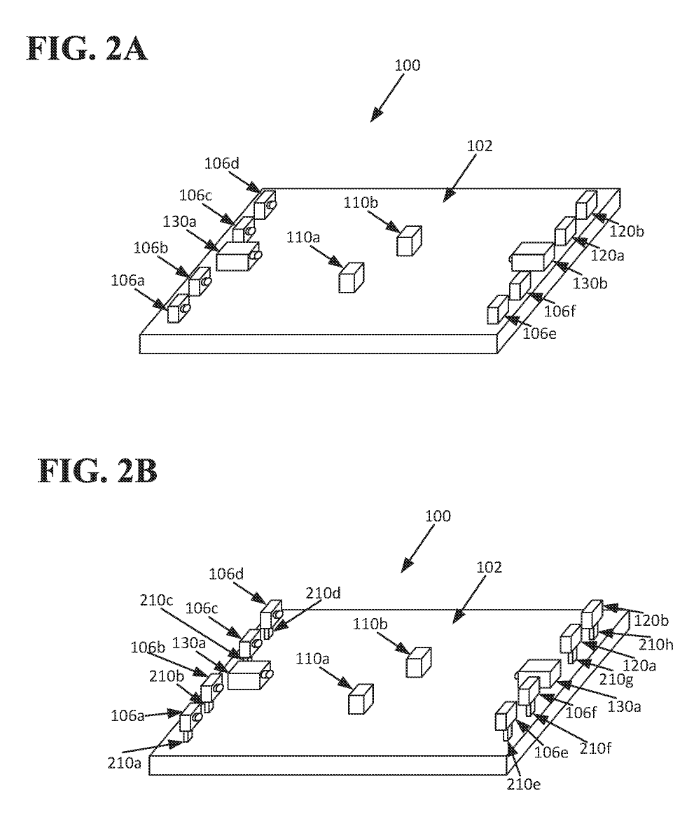

FIG. 2A shows an example system suitable for a real-time motion capture and projection system according to an implementation of the disclosed subject matter. Infrared cameras may be positioned on or parallel to and above the surface 102 of the area 100, and may be used in conjunction with, or without, infrared cameras below the surface 102. For example, the infrared cameras 106a, 106b, 106c, 106d, 106, and 106f may be positioned on the surface 102 in the area 100, instead of being positioned below the surface 102. The infrared cameras 120a and 120b may also be positioned on the surface 102, instead of being positioned elevated off the surface 102. The target objects 110a and 110b may be above the surface 102. The projectors may also be positioned on or parallel to and above the surface 102. For example, the projectors 130a and 130b may be positioned on the surface 120.

FIG. 2B shows an example system suitable for a real-time motion capture and projection system according to an implementation of the disclosed subject matter. Infrared cameras may be positioned on or parallel to and above the surface 102 of the area 100, and may be used in conjunction with, or without, infrared cameras below the surface 102. For example, the infrared cameras 106a, 106b, 106c, 106d, 106e, and 106f may be positioned parallel to and above the surface 102 in the area 100, instead of being positioned below the surface 102. The infrared cameras 120a and 120b may also be positioned above and parallel to the surface 102, instead of being positioned elevated higher off the surface 102. Floor mounts 210a, 210b, 210c, 210d, 210e, 210f, 210g, and 210h may be used to elevate respective infrared cameras 106a, 106b, 106c, 106d, 106e, 106f, 120a, and 120b off the surface 120. This may allow for elevation of infrared cameras when the area 200 does not include any objects to which the infrared cameras may be attached to elevate them, such as walls. The floor mounts 210a, 210b, 210c, 210d, 210e, 210f, 210g, and 210h may be of any suitable type, may be adjustable, and may also be controllable, for example, from a computing device, which may be able to adjust the height and orientation of attached infrared cameras by controlling the floor mounts.

Positioning the infrared cameras 106a, 106b, 106c, 106d, 106e, 106f, 120a, and 120b on the surface 102, or above the surface 102 using the floor mounts 210a, 210b, 210c, 210d, 210e, 210f, 210g, and 210h, may allow for portability and easier setup in variety of different types of areas. The infrared cameras, projectors, and floor mounts may be brought to a location that may serve as the area 100 without requiring the surface 102 of the area 100 have a space, such as the space 104, below it, and without requiring that the surface 102 be transmissive to infrared radiation. For example, the infrared cameras 106a, 106b, 106c, 106d, 106e, 106f, 120a, and 120b, and projectors 130a and 130b, with or without the floor mounts 210a, 210b, 210c, 210d, 210e, 210f, 210g, and 210h, may be set up on an indoor wooden parquet basketball court or outdoor asphalt basketball court without requiring any modifications to the basketball courts.

Target objects, such as the target objects 110a and 110b, may be tracked in the same manner when the infrared cameras 106a, 106b, 106c, 106d, 106e, 106f, 120a, and 120b are on or parallel to and above the surface 102 as when the infrared cameras 106a, 106b, 106c, 106d, 106e, 106f, 120a, and 120b, are positioned below, or higher above, the surface 102. The motion capture data may be used to generate the three-dimensional models of the target objects 110a and 110b in the same manner. The motion capture data, the three-dimensional models of any target objects, such as the target objects 110a and 110b, and the design data stored in the memory of the computing device may be used to generate projector instructions in the same manner, and the projector instructions may be used to project designs specified in the design data onto target objects, such as the target objects 110a and 110b, in the same manner.

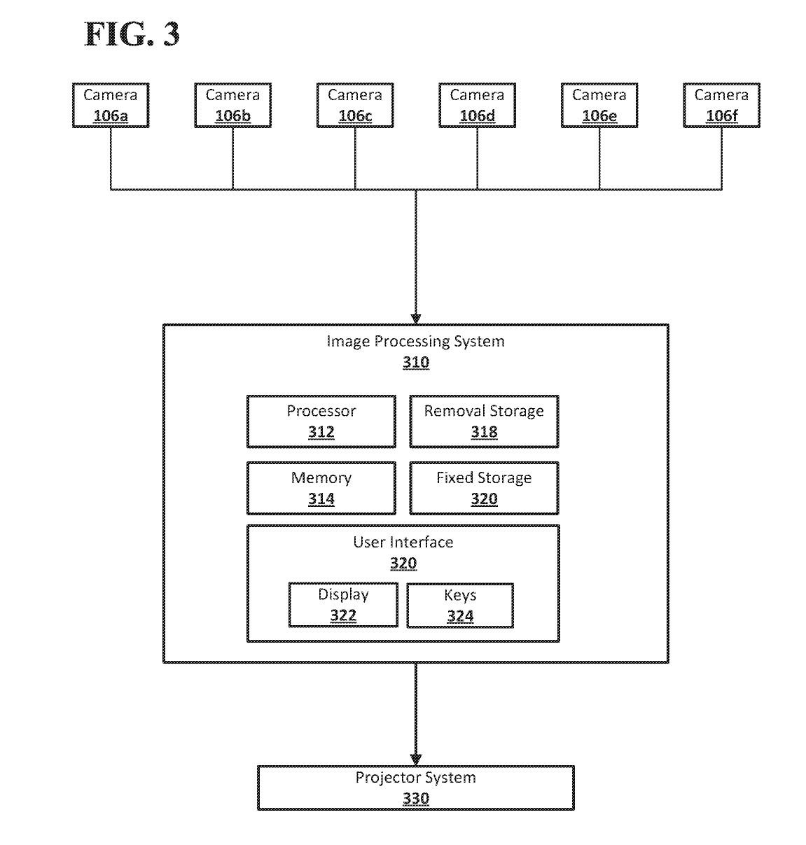

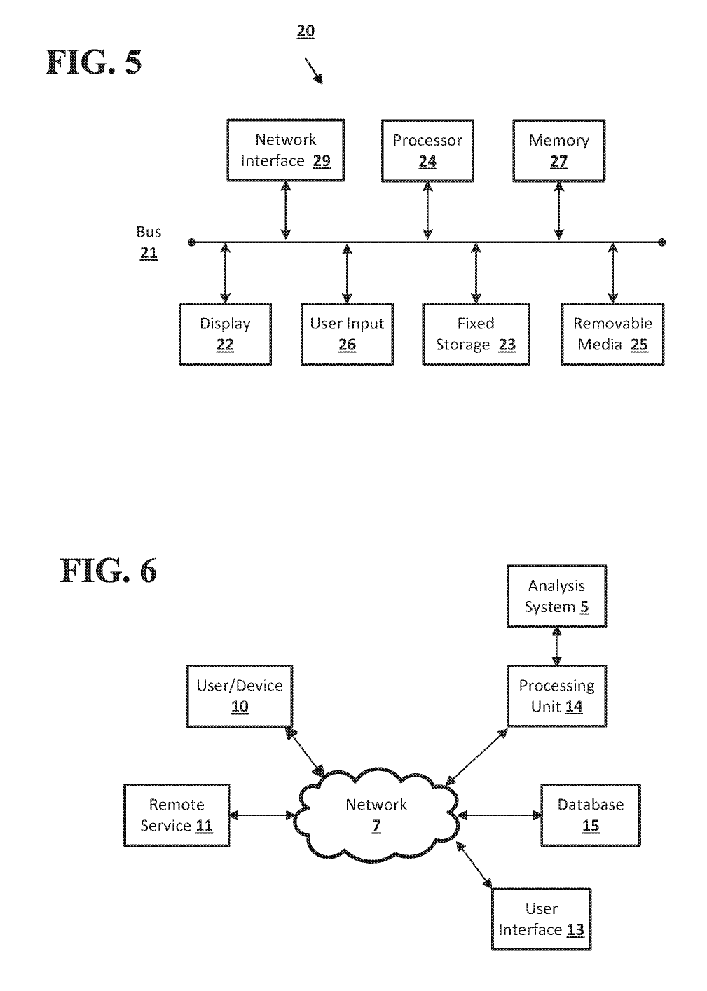

FIG. 3 shows an example system suitable for a real-time motion capture and projection system according to an implementation of the disclosed subject matter. Infrared cameras, such as the infrared cameras 106a, 106b, 106c, 106d, 106e, and 106f, may be positioned throughout the area 100. The infrared cameras 106a, 106b, 106c, 106d, 106e, and 106f may be communicably coupled to an image processing system 310. The image processing system 310 may be any suitable computing device, such as a computer 20 as described in FIG. 5. The image processing system 310 may be, for example, a single computing device, or may include multiple connected computing devices, and may be, for example, a laptop, a desktop, an individual server, a server farm, or a distributed server system, or may be a virtual computing device or system. The image processing system 310 may be part of a computing system and network infrastructure, or may be otherwise connected to the computing system and network infrastructure. The image processing system 310 may be, for example, located in or near the area 100, or may be located remotely.

The image processing system 310 may include various elements for processing images captured by infrared cameras, such as the infrared cameras 106a, 106b, 106c, 106d, 106e, and 106f. The image processing system 310 may include, for example, a processor 312, a memory 314, a fixed storage 316, a removal storage 318, and a user interface 320. The memory 314, the fixed storage 316, the removable storage 318 and the user interface 320 may be coupled to the processor 312 in various manners. The user interface 320 may include a display 322 and keys 324 to allow a user to edit, enhance, or manipulate images or motion pictures, and make changes to, for example, the design date for target objects. The keys 324 may be part of a keyboard, a keypad, or soft keys on a touch screen which also serves as the display 322, for example. The user interface 320 may also include any other suitable input device, such as a mouse, touchscreen, or drawing tablet, in addition to or in place of the keys 324.

The image processing system 310 may process infrared images captured by the infrared cameras 106a, 106b, 106c, 106d, 106e, and 106f and transmitted to the image processing system 310 as part of the motion capture data. The infrared cameras 106a, 106b, 106c, 106d, 106e, and 106f may track movements of infrared markers in the area 100, and the image processing system 310 may process moving images captured by the 106a, 106b, 106c, 106d, 106e, and 106f and generate a motion picture accordingly. The infrared cameras 106a, 106b, 106c, 106d, 106e, and 106f may be communicably coupled to the image processing system 310 in various manners, for example, by wired connections such as High-Definition Multimedia Interface (HDMI) cables, Universal Serial Bus (USB) cables, coaxial cables, Ethernet cables, or the like, by wireless connections such as Bluetooth, Wi-Fi, cellular connections, or the like, or a combination of wired and wireless connections. The infrared cameras 106a, 106b, 106c, 106d, 106e, and 106f may be connected to the image processing system 310 directly, or through a private, semiprivate or public network such as the Internet.

The image processing system 310 may use the motion capture data to generate a three-dimensional model of any target objects in the area 100. The image processing system 310 may use design data for any target objects in the area 100 and the motion capture data and three-dimensional models to generate projector instructions. The projector instructions may specify processed images or motion pictures generated by the image processing system 310 that may be projected by the projector system 330. The projector system 330 may include several projectors, such as the projectors 130a, 130b, 130c, and 130d, positioned around the area 100 to operate together to accurately project images based on design data and sensor data onto all or part of target objects in the area 100, such as the target objects 110a and 110b. Images may include one or more colors, textures, graphic designs, photographs and video images. In some instances, edited, enhanced or modified images or motion pictures generated by image processing system 310 may be projected by the projector system 330. The projector instructions may include an image for each projector 130a, 130b, 130c, and 130d generated based on the location of the projector.

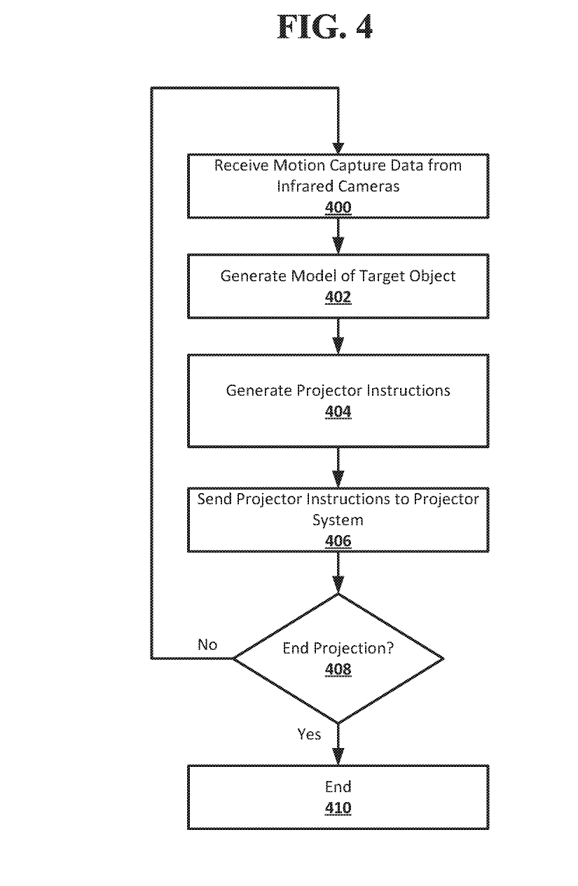

FIG. 4 shows an example procedure suitable for a real-time motion capture and projection system according to an implementation of the disclosed subject matter. At 400, motion capture data may be received from infrared cameras. For example, the image processing system 310 may receive motion capture data from infrared cameras, such as the infrared cameras 106a, 106b, 106c, 106d, 106e, 106f, 120a, 120b, 120c, 120d, 120e, and 120f. The motion capture data may include, for example, infrared images of the area 100, which may capture infrared emissions or reflections from infrared markers within the area, including infrared markers affixed to target objects, such as the target objects 110a and 110b.

At 402, models of target objects may be generated. For example, the image processing system 310 may generate a three-dimensional model of the target objects 110a and 110b, including the location and orientation of the target objects 110a and 110b within the area 100. The three-dimensional model may be based on the motion capture data received from the infrared cameras 106a, 106b, 106c, 106d, 106e, 106f, 120a, 120b, 120c, 120d, 120e, and 120f. The locations at which infrared markers on the target objects 110a and 110b appear in the infrared images in the motion capture data may be correlated with each other and with location and orientation date for the infrared cameras to determine the location of the infrared markers, and the location and orientation of the target objects 110a and 110b to which the infrared markers are affixed, within the area 100. The three-dimensional model of a target object may be based on a pre-existing three-dimensional model for the target object.

At 404, projector instructions may be generated. For example, the image processing system 310 may use the motion capture data, three-dimensional models of the target objects 110a and 110b, and design data for the target objects 110a and 110b to generate projector instructions for the projector system 330. The design data may specify designs for the target objects 110a and 110b, and may include, for example, appearance data for the target objects 110a and 110b, such as colors, shapes, textures, and patterns for various areas of the target objects 110a and 110b. The projector instructions may specify images, and may cause the projectors of the projector system 330, for example, the projectors 130a, 130b, 130c, and 130d, to project the image, including colors, textures, shapes, and patterns onto the appropriate areas of the target objects 110a and 110b, so that the target objects appear with the design specified in the design data. The projector instructions may specify an image for each of the projectors 130a, 130b, 130c, and 130d. The images for each projector may be generated based on the location and orientation of each projector in the area 100.

At 406, the projector instructions may be sent to a projector system. For example, the projector instructions generated by the image processing system 310 may be sent to the projectors 130a, 130b, 130c, and 130d of the projector system 330. The projector instructions may cause the projectors 130a, 130b, 130c, and 130d to project the designs specified in the design data onto the target objects 110a and 110b using visible light.

At 408, if the projection is ended, flow may proceed to 410 and end. If the projection is not ended, flow may proceed back to 400, where new motion capture data may be received from the infrared cameras and used to generate a new models of the target objects 110a and 110b and new projector instructions. This may allow for designs to be projected onto the target objects 110a and 110b as they move through the area 100. The design data for the target objects 110a and 110b may be changed at any step, resulting in real-time changes to the design projected on to the target objects 110a and 110b.

Implementations of the presently disclosed subject matter may be implemented in and used with a variety of component and network architectures. FIG. 5 is an example computing device 20 suitable for implementations of the presently disclosed subject matter. The computing device 20 may be, for example, a user device such as a desktop or laptop computer, or a mobile computing device such as a smartphone, tablet, or the like. The computing device 20 includes a bus 21 which interconnects major components of the computer 20, such as a central processor 24, a memory 27 (typically RAM, but which may also include ROM, flash RAM, or the like), an input/output controller 28, a user display 22, such as a display screen, a user input interface 26, which may include one or more controllers and associated user input devices such as a keyboard, mouse, touchscreen, and the like, a fixed storage 23, such as a hard drive, flash storage, and the like, a removable media component 25 operative to control and receive an optical disk, flash drive, and the like, and a network interface 29 operable to communicate with one or more remote devices via suitable network connection.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25. In some implementations, the bus 21 may provide communications between various components of the computing device 20 and the infrared cameras as shown in FIG. 1, 2 or 3.

The fixed storage 23 may be integral with the computer 20 or may be separate and accessed through other interfaces. A network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below. In some implementations, the network interface 29 may provide communications between various components of the computing device 20 and the infrared cameras as shown in FIG. 1, 2 or 3. For example, the network interface 29 may allow the computer to communicate with other computers via one or more local, wide-area, or other networks, as shown in FIG. 6.

Many other devices or components (not shown) may be connected in a similar manner (e.g., document scanners, digital cameras, and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an implementation of the disclosed subject matter. One or more devices 10 and 11, such as user devices, local computers, smartphones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10 and 11, or one or more other devices may provide intermediary access such as where a server 13 provides access to resources stored in a database 15. The devices 10 and 11 also may access a remote platform 17 or services provided by remote platforms 17 such as cloud computing arrangements and services. The remote platform 17 may include one or more servers 13 and/or databases 15. In some implementations, the server 13 may be an application store server that is capable of performing any of the processes described above.

In some implementations, the image processing system 310 as shown in FIG. 3 may be physically located remotely from the infrared cameras 302a, 302b, . . . 302f. The infrared cameras and the image processing system may be connected through a network, for example. Referring to FIG. 5, the devices 10 and 11 may be infrared cameras, and various components of the image processing system may reside in the remote platform 17, the server 13, the database 15, or a combination thereof. For example, the remote platform 17 may include a processor that processes moving images of infrared markers captured by the infrared cameras, i.e., devices 10 and 11, and processed data may be stored in the database 15. The server 13 may allow authorized users to access the processed data stored in the database 15 and to use the processed data for various purposes, such as displaying or projecting moving images of the subject, or moving images of an area of interest of the subject, as captured by the infrared cameras.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. An apparatus comprising:
one or more infrared cameras disposed in an area, wherein the infrared cameras generate infrared images of portions of the area and transmit the infrared images as motion capture data;
an image processing system, wherein the image processing system receives the motion capture data from the infrared cameras and generate projector instructions; and
one or more projectors disposed in the area, wherein the projectors receive the projector instructions from the image processing system and project visible light according to the projector instructions.

2. The apparatus of claim 1, further comprising infrared markers that at least partially reflect radiation in at least part of at least one range of wavelengths detected by the one or more infrared cameras, the infrared markers disposed on at least one target object.

3. The apparatus of claim 1, further comprising infrared markers that emit radiation in at least part of at least one range of wavelengths detected by the one or more infrared cameras, the markers disposed on at least one target object.

4. The apparatus of claim 1, wherein the image processing system generates a three-dimensional model of at least a part of a target object based on the motion capture data.

5. The apparatus of claim 4, wherein the image processing system generates the projector instructions based on the motion capture data, design data for at least the part of the target object, and the three-dimensional model of at least the part of the target object.

6. The apparatus of claim 5, wherein the visible light projected from the one or more projectors is projected onto at least the part of the target object.

7. The apparatus of claim 5, wherein the projector instructions comprise an image.

8. The apparatus of claim 5, wherein the projector instructions comprise one or more of: at least one texture designation, at least one color designation, and at least one area designation.

9. The apparatus of claim 5, wherein the image processing system tracks the position of at least the part of the target object over time using the motion capture data and wherein the projector instructions generated by the image processing system include a plurality of directional designations to project visible light on at least the part of the target object at the position of the target object changes over time.

10. The apparatus of claim 9, wherein the design data includes at least one area designation and wherein the image processing system generates projector instructions to project visible light onto the target object based on a color designation and the at least one area designation of the design data.

11. The apparatus of claim 1, wherein the infrared cameras are one or more of disposed on a surface of the area, disposed below the surface of the area, and disposed above the surface of the area.

12. A method comprising:
receiving motion capture data indicating the location of at least one marker affixed to a target object;
generating a three-dimensional model of the target object based on the location of the at least one marker indicated in the motion capture data;
generating projector instructions based on the three-dimensional model of the target object, design data for the target object, and the motion capture data; and
transmitting the projector instructions to one or more projectors to cause at least one of the projectors to project visible light.

13. The method of claim 12, wherein the at least one marker comprises an infrared marker, and wherein the motion capture data is received from infrared cameras.

14. The method of claim 12, wherein the projector instructions comprise an image and cause the at least one of the projectors to project the image using visible light.

15. The method of claim 14, wherein the image comprises at least a part of a design indicated in the design data for the target object.

16. The method of claim 12, wherein the design data comprises a designation of at least one of a shape, a color, a texture, and a pattern.

17. The method of claim 12, wherein the design data comprises a designation of at least one area of the target object.

18. A computer-implemented system comprising:
a memory storing design data for a target object;
one or more communications devices for communicating with one or more sensors; and
a processor that generates a three-dimensional model of the target object based on a location of at least one marker indicated in motion capture data received using at least one of the communications devices, generates projector instructions based on the three-dimensional model of the target object, the design data for the target object, and the motion capture data, and transmits, using at least one of the communications device, the projector instructions to one or more projectors to cause at least one of the projectors to project visible light.

19. The computer-implemented system of claim 18, wherein the at least one marker comprises an infrared marker, and wherein the motion capture data comprises at least one infrared image.

20. The computer-implemented system of claim 18, wherein the design data indicates a design for the target object, the design comprising an indication of at least one texture, color, pattern, or shape.

21. The computer-implemented system of claim 18, wherein the image processing system further receives updated design data, and generates the projector instructions based on the updated design data.

22. The computer-implemented system of claim 18, wherein projector instructions comprise an image to be projected by at least one of the one or more projectors.

23. A system comprising: one or more computers and one or more storage devices storing instructions which are operable, when executed by the one or more computers, to cause the one or more computers to perform operations comprising:
receiving motion capture data indicating the location of at least one marker affixed to a target object;
generating a three-dimensional model of the target object based on the location of the at least one marker indicated in the motion capture data;
generating projector instructions based on the three-dimensional model of the target object, design data for the target object, and the motion capture data; and
transmitting the projector instructions to one or more projectors to cause at least one of the projectors to project visible light.
